(19) United States
(12) Patent Application Publication
(10) Pub. No.: US 2025/0303361 A1
(43) Pub. Date: Oct. 2, 2025

(54) SYSTEM AND METHOD FOR OXIDATIVE ADSORPTION IN A MOVING BED REACTOR WITH REGENERATED ACTIVATED CARBON

(71) Applicant: Baisheng ZOU, Spring, TX (US)

(72) Inventor: Baisheng ZOU, Spring, TX (US)

(21) Appl. No.: 18/619,898

(22) Filed: Mar. 28, 2024

(51) Int. Cl. B01D 53/83; B01D 53/50; B01D 53/56; B01D 53/96; B01J 20/20; B01J 20/34

(52) U.S. Cl. CPC B01D 53/83; B01D 53/508; B01D 53/565; B01D 53/96; B01J 20/20; B01J 20/3416; B01J 20/3475; B01D 2253/102; B01D 2257/302; B01D 2257/404

(57) ABSTRACT

Disclosed are a system and process to economically regenerate activated carbon used in oxidative adsorption of gas molecules. The regenerated activated carbon can reduce mass transfer limitation of reactants of oxidative adsorption and increase overall gas adsorption rate and efficiency. The regeneration process includes a downcomer, an extractor, a decanter, a dryer, and a recirculation loop of activated carbon particles. Activated carbon particles are transferred from one unit operation to another, to complete the tasks of extraction of oxidative products, washing and cleaning of carbon particles, decanting of exterior and surface water between particles and drying the interior of particles via vaporization. Adsorption and oxidation of gas molecules with a moving bed reactor is used to complete a reaction/regeneration cycle. Removal of the rate limiting liquid from exterior voids and interior pores of activated carbon particles efficiently could enable a much higher overall rate of gas adsorption.

### CROSS-REFERENCE TO RELATED APPLICATIONS

Not applicable.

### BACKGROUND OF THE INVENTION

Using activated carbon to remove gas phase sulfurous compounds is widely studied in academia [1, 2, 3, 4] and practiced in many industrial installations [5]. A particular subset of activated carbon adsorption is oxidative adsorption in which adsorbed molecules are oxidized. Oxidative adsorption allows much higher adsorption capacity than physical/chemical adsorption alone.

Examples of oxidative adsorption are sulfurous compounds adsorption in the presence of oxygen and moisture. The chemical reaction equations are as follow with activated carbon as catalyst and adsorbent:

SO₂+½O₂+H₂O═H₂SO₄ (1)

H₂S+2O₂═H₂SO₄ (2)

COS+2O₂+H₂O=H₂SO₄+CO₂ (3)

CS₂+4O₂+2H₂O=2H₂SO₄+CO₂ (4)

Except for the Reaction (1) which produces final product H₂SO₄ only, all other reactions will have various intermediate oxidation products such as S₈, H₂S₂O₃ and H₂SO₃, etc.

Another example of oxidative adsorption is NO adsorption on activated carbon:

2NO+1½O₂+H₂O=2HNO₃ (5)

Reaction (5) could generate intermediate products such as HNO₂.

The traditional catalyst for SO₂ oxidation is vanadium catalyst. Vanadium catalyst is only active at above 750° F. conditions. The reaction rate would be limited by equilibrium at high conversion and high temperature, resulting in a tail gas of about 400 ppm for a double contact double absorption acid plant and 1500 ppm for a single absorption acid plant.

The advantages of converting SO₂ to H₂SO₄ by activated carbon are low reaction temperature and favorable equilibrium conditions. It is able to convert the tail gas of a sulfuric acid plant to below 20 ppm. The main disadvantage of such a process is that H₂SO₄ would cover the active sites and clog the pore structures of activated carbon. Carbon regeneration is required to continue the adsorption/oxidation operation once the carbon is loaded with sulfuric acid. A common problem with the oxidative adsorption process is that there are difficulties in removing produced H₂SO₄ or HNO₃ and regenerating the spent activated carbon.

In general, regeneration of spent activated carbon, often referred to as reactivation, is a method of thermally processing the activated carbon to destroy the adsorbed components contained on its surface. In regeneration, the adsorbed components are almost completely removed, yielding a regenerated carbon that can again function as an absorbent.

The spent activated carbon is first dried. Once the material has been dried to the desired moisture content, volatilization can occur. The material is heated up to around 1000° F., which volatilizes 75-90% of the adsorbed materials. At this point, steam is injected into the system to remove the remaining volatiles and “reactivate” the carbon. During this process, it is common to have carbon losses between 5-10%. Rotary kilns and multiple hearth furnaces are the two most used equipment for spent activated carbon regeneration.

Specifically, there are two methods to regenerate H₂SO₄ laden activated carbon, thermal regeneration and water wash regeneration.
1. Thermal Regeneration Method (GE-MITSUI-BF activated coke process [6]). Heating to 720° F. would convert H₂SO₄ back to SO₂ with the following reaction:

2H₂SO₄+C=2SO₂↑+CO₂↑+2H₂O↑ (6)
There is a loss of carbon with each regeneration because carbon is converted to CO₂ in Reaction (6). Moreover, SO₂ from the original gas is not destroyed after the spent carbon regeneration; instead, regeneration creates a higher concentration SO₂ stream that needs to be treated further, such as being converted to strong H₂SO₄ (>93.5 wt %) in a contact sulfuric acid plant.
2. Water Wash Regeneration Method (Sulfacid process by Lurgi [5]). H₂SO₄ is leached out from activated with water, and the effluent is a 7-15 wt % weak sulfuric acid. There is no net consumption of carbon with the water washing regeneration method. Most wet activated carbon processes use wet carbon bed reactors as shown by FIG. 1. These types of reactors suffer from low reaction rates due to liquid phase mass transfer limitations of O₂ and SO₂ within the carbon particles.

Neither method has many industrial installations due to limitations mentioned above.

The simplest activated carbon (AC) reactor for SO₂ adsorption is a packed bed reactor. FIG. 1 is a schematic drawing of a packed bed reactor. SO₂ is used here for illustration purposes, other molecular compounds can be removed similarly. In this reactor, gas adsorption/reaction and carbon regeneration happen in the same vessel. Gas flows (1) continuously from top to bottom, through the activated carbon bed (5). SO₂ is converted into sulfuric acid on the internal surface of the carbon particles. The processed gas (4) with reduced SO₂ concentration is then sent to the stack. Once the carbon particles are saturated with sulfuric acid, which is indicated by an increase in SO₂ emissions at the stack, water wash (2) regeneration is started. A weak sulfuric acid stream (3) is removed from the bottom of the reactor after being extracted by regeneration water.

For SO₂ oxidation to happen, oxygen and SO₂ must transfer from the gas phase to internal carbon surface. If the bed is wet with water or H₂SO₄, oxygen and SO₂ must diffuse through the liquid to reach the internal active sites. It can be shown that mass transfer of oxygen is the rate limiting step with a wet carbon bed. The reason is that the solubility and diffusivity of oxygen are very low both in water and in sulfuric acid.

After a certain reaction time, the carbon bed is loaded with sulfuric acid and carbon regeneration with water wash is required. Water mixed with sulfuric acid would generate a lot of heat, causing the bed temperature to spike initially after water flow starts. As water continues to flow, H₂SO₄ would leach out of carbon particles and be carried out of the reactor as weak sulfuric acid. When the water flow stops, some of the water would stay in the void space between particles and some would stay inside the particles.

Gas flows continuously through the bed even during the regeneration cycle. When water flow stops, a lot of water stays in the reactor. Right after the stop of water flow, the reaction rate is slow because O₂ and SO₂ need to diffuse through water to reach the active sites. Liquid phase diffusion rate is several orders of magnitude less than gas phase diffusion rate. Having water in the bed greatly reduces the rate of mass transfer and the rate of overall reaction. But as gas flow continues, water is evaporated into the gas phase and the carbon bed is gradually dried, and a high reaction rate could develop afterward.

Four major processes, adsorption/reaction, H₂SO₄ extraction, carbon particle washing and cleaning, and bed/particle drying all happen in a single packed bed reactor, and none of them was carried out efficiently. Having all processes happening in a packed bed reactor faces three challenges:
Low reaction rate except in first few weeks of operation, because the carbon is inefficiently regenerated by such a method, and the bed and particles are mostly wet either with H₂SO₄ or with water most of the time.
Material of Construction (MOC) difficulties: The vessel and internal components are in contact with both weak sulfuric acid of 10-30% and a process gas. A single economic material cannot handle both. Stainless steel or Alloy—20 would be corroded in a weak acid (10-30%, temperature spikes to 200° F.) environment, FRP could be charred if SO₃ escapes from a sulfuric acid plant absorbing tower and gets into the vessel, Teflon does not have the mechanical strength for large vessels.
Pressure drops across the carbon bed are high for typical applications of treating tail gases.

FIGS. 2a-2d show various carbon states that affect the reaction rate. FIG. 2a shows a dry and clean carbon particle. SO₂ and O₂ can easily reach the carbon internal surface and the reaction rate is fast. As the reaction continues, sulfuric acid (H₂SO₄) is produced and it occupies the internal surface of the carbon particle, as shown by FIG. 2b. H₂SO₄ prevents the SO₂ and O₂ from reaching the internal carbon surface, and reaction rate slows down. In order to restore the catalyst activity, water is used to wash the H₂SO₄ out, as shown in FIG. 2c. With both H₂SO₄ and water in the catalyst particle, the reaction rate is again low.

Most of the H₂SO₄ would be eventually removed from the carbon particle by water wash and leaching of H₂SO₄, the carbon particle would be free of H₂SO₄, but water would remain on the particle as shown in FIG. 2d. The reaction rate is still slow in State (d) since water is still preventing SO₂ and O₂ from accessing the carbon internal surface. The reaction rate could only be high if all the water is decanted and evaporated from the carbon bulk and particles and the carbon becomes dry and clean again as shown by FIG. 2(a).

There are some industrial applications which use activated carbon bed reactors for sulfurous compounds removal under continuous water flow. This is equivalent to a state somewhere between (c) and (d). By design, the reaction rate is very limited. In such cases, a lot more carbon has to be used to compensate for the low reaction rate.

A packed bed reactor with intermittent water wash is also possible. In this case, the reactor cycles through (a) to (d). When it is in states from (b) to (d), the reaction rate is low. It takes a long time for a packed bed carbon reactor to transition from State (d) to State (a), since there is no effective way of drying carbon in a packed bed reactor. Therefore, a packed bed reactor with intermittent wash will have a low reaction rate during much of the time.

The key to having a fast reaction with water wash regeneration method is to remove all liquid, both liquid water and H₂SO₄, from the carbon to allow access of active sites by O₂ and SO₂.

The following quantitative analysis can illustrate the importance of removing mass transfer limitation. At steady states, the reaction rate of Reaction (1) of a single carbon particle equals to mass transfer rate and is described by the following equation:

$$R = reaction rate = mass transfer rate = {D}_{O 2} A ( {C}_{O 2 S} - {C}_{O 2 R} ) / L \qquad ( 7 )$$

Where,
   DO₂: Diffusivity of O₂
   C_{O2S}: Concentration of O₂ on particle surface
   CO_{2R}: Concentration of O₂ at reactive sites
   A: Exterior surface area of a particle
   L: Mass transfer length

If the surface concentration is much higher than the interior concentration C_{O2S}>>C_{O2R} then R is proportional to D_{O2}C_{O2S}, which is a parameter to be used next to compare mass transfer rates.

Diffusivities of O₂ and SO₂ in liquid and in dry activated carbon are listed in Table 1. To be conservative, Knudsen diffusivity, instead of gas phase diffusivity, is used here for gas phase diffusion inside a carbon particle since the carbon pore size is less than the mean free path of the gas molecules. O₂ diffusivity in air is 0.2 cm2/s, which is much larger than its Knudsen diffusivity and could give a too optimistic rate estimation.

TABLE 1
Diffusivities of O₂ and SO₂

| | Diffusivity | | Diffusivity |
|---|---|---|---|
| Species | (cm²/s) | Species | (cm²/s) |
| O₂(l)-Water(l) | 2.4 × 10⁻⁵ | SO₂(l)-Water(l) | 1.82 × 10⁻⁵ |
| O₂(g)-AC(Knudsen) | 0.01 | SO₂(g)-AC(Knudsen) | 0.007 |

The solubility of O₂ in water (I) is 1.22×10⁻³ mole/I/atm, and the solubility of SO₂ in water (1) is 1.47 mole/l/atm.

For a double absorption sulfuric acid plant tail gas, 5% O₂ and 400 ppm SO₂ are typical. Ideal gas law and solubility data can be used to estimate surface concentration of O₂ and SO₂ under dry and wet activated carbon conditions, which is listed in Table 2.

TABLE 2
Concentration of Species on Particle
Surface CXS at Dry and Wet Conditions
(X = O₂ or SO₂, 5% O₂ and 400 ppm
SO₂ at one atm and 25° C.)

| | Surface Concentration of | Surface Concentration of |
|---|---|---|
| Species | Totally Dry Particle (mole/l) | Totally Wet Particle (mole/l) |
| O₂ | 2.2 × 10⁻³ | 6.1 × 10⁻⁵ |
| SO₂ | 1.8 × 10⁻⁵ | 5.9 × 10⁻⁴ |

The products of diffusivities and surface concentrations are used to compare reaction rate of different scenarios, as shown in Table 3.

TABLE 3
Product of Diffusivity and Surface
Concentration at Dry and Wet Conditions
(D_{X}C_{XS} where X = O₂ or SO₂, 5% O₂
and 400 ppm SO₂ at one atm and 25° C.)

| | Knudsen Diffusion | Molecular Diffusion | |
|---|---|---|---|
| | in Dry Particle | in Wet Particle | Ratio |
| Species | (mole/l*cm²/s) | (mole/l*cm²/s) | (Dry/Wet) |
| O₂ | 2.2 × 10⁻⁵ | 1.5 × 10⁻⁹ (b, c, d) | 1.5 × 10⁴ |
| SO₂ | 1.3 × 10⁻⁷ (a) | 1.1 × 10⁻⁸ | 12.1 |

The rate limiting step in a particular case is the step with the least rate value. The above table indicates that O2 mass transfer in a wet particle has lowest values. Reaction rate is the lowest for states b, c, and d because of O₂ diffusion in liquid. As the particle dries, O₂ mass transfer becomes larger and non-limiting. When the particles are dry, SO₂ mass transfer becomes a limiting step. The reason is because SO₂ concentration is only 400 ppm in gas phase, which makes D_{SO2}C_{SO2S} much smaller than that of O₂.

Regeneration of activated carbon to a H₂SO₄ free and liquid water free state (a) would have potential rates increase: Rₐ/R_{b,c,d}=87 times. The potential rate increases by regeneration could be less than 87 times, if the intrinsic reaction kinetic rate is less than the SO₂ mass transfer rate after the particle is regenerated. Preliminary estimation indicated that intrinsic kinetic rate is not rate limiting at the targeted process conditions.

The activated carbon is not fully regenerated just by removing H₂SO₄, the water remaining in the carbon bed and carbon pores must be removed and evaporated as well to have a fully regenerated carbon adsorbent that is good for SO₂ adsorption and oxidation.

### SUMMARY OF THE INVENTION

The present invention is a system for oxidative adsorption with a regenerated active carbon. The system includes a moving bed reactor having a process gas inlet adjacent a bottom thereof and a regenerated carbon inlet adjacent a top thereof. A downcomer is in fluid communication with the bottom of the moving bed reactor such that carbon particles from the moving bed reactor pass into the downcomer. The downcomer has a fluid outlet. An extractor is in fluid communication with a bottom of the downcomer, and has a fluid inlet adjacent a top thereof. The extractor is adapted to move the carbon particles received from the downcomer in an upward direction. A system includes a dryer having a first end and a second end. The first end is connected to the top of the extractor so as to receive carbon particles from the extractor, and the second end is connected to the regenerated carbon inlet of the moving bed reactor so as to introduce carbon particles to the moving bed reactor.

In an embodiment, the extractor has a conveyor screw with a rotating shaft.

In an embodiment, the dryer is a rotary drum dryer.

In an embodiment, the system includes a blow dryer positioned in a conduit between the top of the extractor and the first end of the dryer.

In an embodiment, the moving bed reactor has a carbon dioxide inlet adjacent the bottom thereof.

In an embodiment, a sleeve is positioned between the moving bed reactor and the downcomer.

In an embodiment, the moving bed reactor includes a plurality of screen cages with a plurality of channels therebetween, wherein the carbon particles from the dryer pass through the plurality of channels towards the downcomer. The moving bed reactor may also include a rotary scraper positioned above the plurality of screen cages, wherein the rotary scraper is adapted to push the carbon particles into the plurality of channels. The plurality of screen cages may be concentrically arranged.

In an embodiment, the moving bed reactor may also include a distributor positioned below the plurality of screen cages, the distributor having a plurality of openings aligned with the plurality of screen cages so as to allow process gas to pass from the process gas inlet into the distributor and into the plurality of screen cages. The distributor may have a plurality of sloped walls positioned on opposite sides of each of the plurality of openings such that carbon particles passing through the plurality of channels of the moving bed reactor slide along the sloped walls so as to be guided into the downcomer.

In an embodiment, the plurality of screen cages are provided with a plurality of blockages so as to define a gas path through the plurality of screen cages and the plurality of channels.

In an embodiment, the downcomer has a cone-shaped bottom.

In an embodiment, the sleeve is constructed of Telfon®, the moving bed reactor is constructed of carbon steel, and the downcomer is constructed of fiber-reinforced plastic (FRP). The sleeve is preferably positioned so as to line the interior of the downcomer.

The present invention is also a method for oxidative adsorption in a moving bed reactor with a regenerated active carbon, the method comprising: passing a process gas through a moving bed reactor, the moving bed reactor containing activated carbon particles; flowing the activated carbon particles into a downcomer connected to an extractor, the downcomer and extractor containing a leeching liquor; washing the activated carbon particles so as to remove oxidative products resulting from the process gas passing through the moving bed reactor; removing the oxidative products from the downcomer, the oxidative products being in the form of a weak acid; moving the washed carbon particles upwardly through the extractor; drying the washed carbon particles; and flowing the dried carbon particles into the moving bed reactor.

In an embodiment, the step of drying comprises: blow drying the washed carbon particles; and further drying the washed carbon particles in a rotary dryer or a fluidized bed dryer.

In an embodiment, the process gas contains sulfurous or nitrogen oxide compounds such as SO₂ NO or H2S, and wherein the weak acids are H2SO₄ or HNO3.

In an embodiment, the moving bed reactor comprises a plurality of screen cages with a plurality of channels therebetween, wherein the activated carbon particles through the plurality of channels towards the downcomer, and wherein the process gas passes through the plurality of screen cages and the plurality of channels.

In an embodiment, the step of drying comprises using tail gas or process gas as a drying gas. This foregoing Section is intended to describe, with particularity, the preferred embodiments of the present invention. It is understood that modifications to this preferred embodiment can be made within the scope of the present claims. As such, this Section should not to be construed, in any way, as limiting of the broad scope of the present invention. The present invention should only be limited by the following claims and their legal equivalents.

### BRIEF DESCRIPTION OF DRAWINGS

FIG. 1 is a schematic view of a packed bed reactor of the prior art.

FIGS. 2a-2d illustrate various carbon states during an oxidative adsorption process.

FIG. 3 is a schematic view illustrating an embodiment of the system and method of present invention.

FIG. 4 illustrates an embodiment of the present invention wherein a continuous decanter centrifuge is utilized in the drying of the carbon particles.

FIG. 5 is a detailed view illustrating the moving bed reactor and downcomer of an embodiment of the present invention.

FIG. 6 illustrates the concentric screen cages of the moving bed reactor of the present invention.

FIGS. 7a-7d are detailed views of the distributor of the present invention.

FIG. 8 is a top view of the moving bed reactor, illustrating the arrangement of the rotary scraper, concentric screen cages and the distributor.

FIG. 9 is a view illustrating the interior of the moving bed reactor and passage of the flue gas and carbon particles therethrough.

FIG. 10 illustrates the interior of the moving bed reactor wherein blocking rings are provided to define pathways for the flue gas.

FIG. 11 illustrates various pathways for the flue gas depending on the placement of the blocking rings.

FIG. 12 illustrates a blade of the rotary scraper of the present invention.

FIG. 13 is a perspective view of the rotary scraper of the present invention.

FIG. 14 illustrates the sleeve of the present invention.

FIG. 15 illustrates an embodiment of the blocking rings of the present invention wherein concentric multi-element filters/mist eliminators are utilized.

### DETAILED DESCRIPTION OF THE INVENTION

The key insight gained from the above analysis is that the best way to speed up reaction rate is to eliminate the build-up of H₂SO₄ and liquid water both exterior and interior of carbon particles.
1. Wash thoroughly to remove H₂SO₄ as much as possible so that only water remains in the particle, since H₂SO₄ could not be evaporated later with a dryer.
2. Dry thoroughly to remove H₂O, by mechanical means for exterior water between particles and by evaporative drying of interior water inside carbon pores.
3. React SO₂ and O₂ with totally regenerated carbon, free from liquid water and with minimal H₂SO₄ as practically achievable.

It is best to keep steps 1, 2 and 3 separated, so that the most efficient equipment and the most appropriate MOC of each category is used for each step, and the overall process is optimized.

Standard industrial drying equipment that is specifically designed for drying particulate matter should be used. The most common particulate matter dryers are rotary drum dryers.

A rotary dryer dries the interior water of carbon particles quickly and efficiently, thereby maximizing the percentage of time the particles spend in State (a) and reducing the amount of catalyst required (and, hence, the capital investment required). Depending on the process requirements, sometimes a fluidized bed dryer could be more appropriate.

The most efficient leaching equipment should be used for oxidation product extraction from carbon particles. With an extractor specifically designed for extraction, less leaching liquor can be used, and liquid product concentration can be increased. Common industrial leaching equipment includes Hildebrandt extractors and Kennedy extractors.

To increase overall thermal efficiency and energy saving, liquid water exterior to particles may be mechanically removed instead of vaporized in a dryer. A blower, a vacuum filter or a continuous centrifugal decanter can be used for such a purpose.

For the oxidative adsorption of gas molecules, a moving bed reactor can be used.

The activated carbon particles need to be transferred from one unit operation to another unit operation. Screw conveyors can be used for this purpose. For vertical lifts, sometimes bucket elevators can be used.

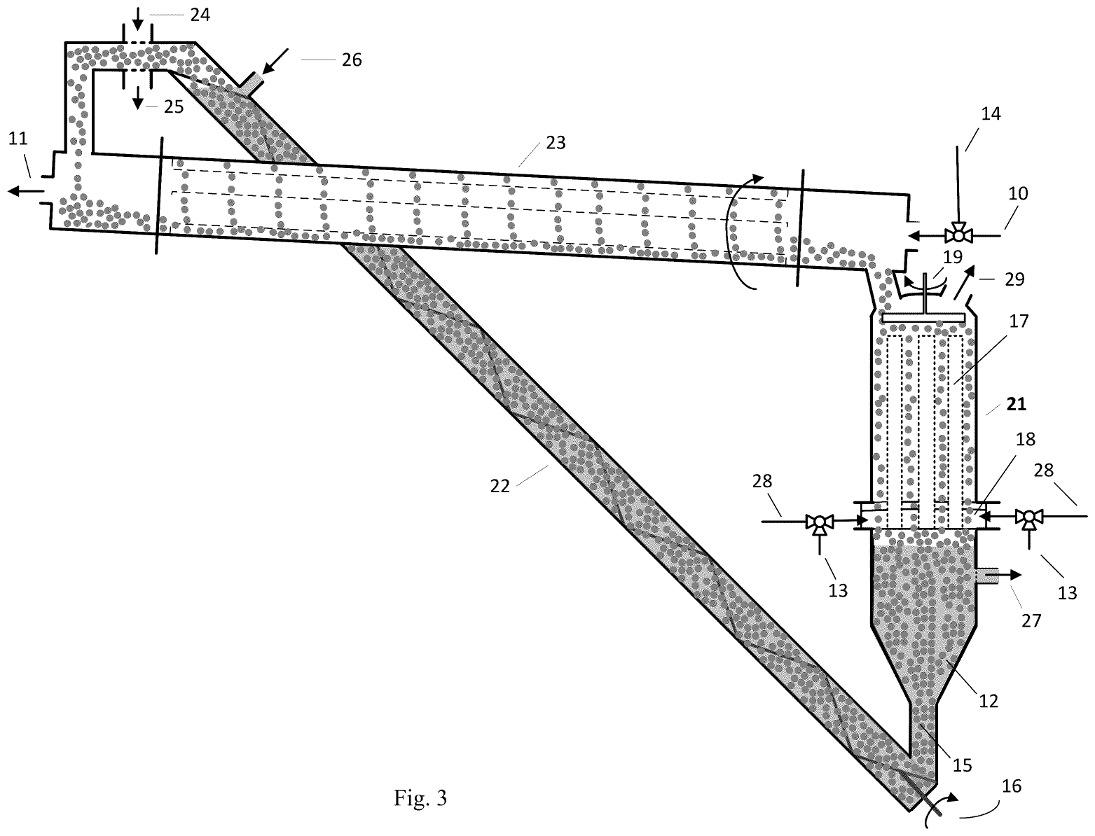

FIG. 3 shows one complete activated carbon regeneration and oxidative adsorption process with a moving bed reactor 21 (MBR) for sulfurous compounds removal, a downcomer 12 and an extractor 22 together for sulfuric acid extraction, a water blow dryer 24/25 and a rotary-dryer 23 for internal water evaporation. Carbon particles are shown as grey beads and liquid is shown as grey shade in FIG. 3.

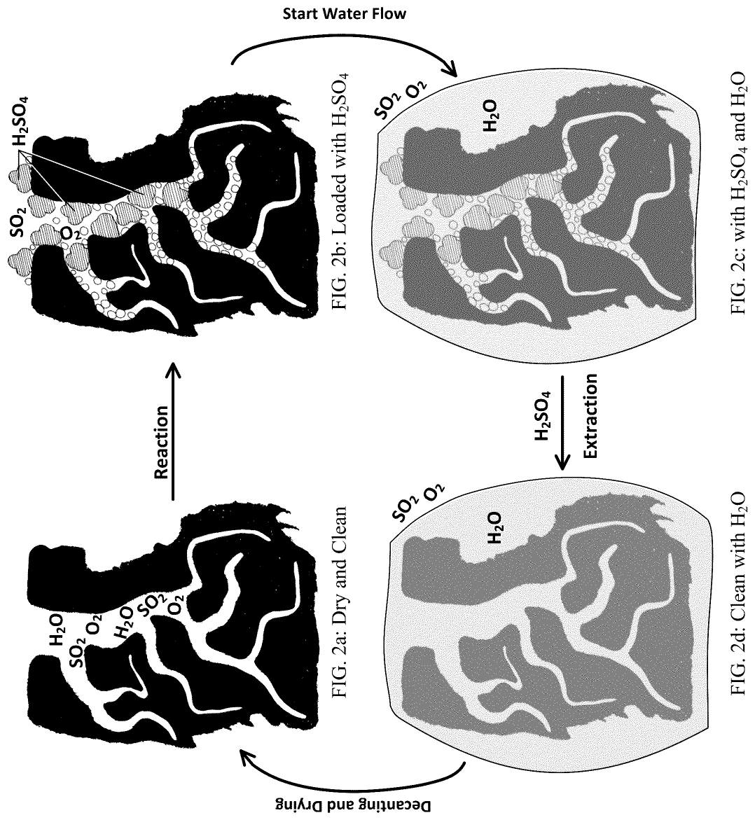

H₂SO₄ saturated carbon [State (b) from FIG. 2a-2d] drops from the lower section of MBR 21 into a downcomer section 12, in contact with liquid water [State (c)], and eventually goes into the lower entrance 15 of extractor 22. The carbon particles are screw conveyed upward in the extractor, becoming free of H₂SO₄ [State (d)] at the upper section of extractor 22. The conveyor screw is powered by a rotating shaft 16. Leaching liquor water 26 enters extractor 22 from a feed nozzle, flows downward and exits the system as weak acid stream 27. The wet carbon, freed of H₂SO₄, is blown or vacuumed to remove water exterior of carbon particles by an air stream 24. Exterior water and exhaust air exit the system as stream 25. Washed and clean wet carbon [State (d)] is dried in a rotary dryer 23 and becomes fully regenerated and active again [State (a), free of liquid water and with minimal H₂SO₄]. This fully regenerated carbon flows into MBR 21 for SO₂ adsorption. SO₂ is removed from flue gas 28 and exits MBR 21 as stream 29. Carbon particles are saturated with H₂SO₄ [State (b)] at the lower section of MBR 21.

There are cases where a rotary dryer alone could also be used to carry out both the drying duty and adsorption/reaction duty if the incoming adsorbed component concentration is very low. In which case an MBR is not necessary.

The drying gas 10 could be a hot combustion air stream or come from the same source as the flue gas stream 28, or a combination of the two. Secondary combustion of a fuel with process gas stream 28 to increase its temperature and reduce its oxygen content can create a drying gas 10 that is inert to accidental activated carbon combustion in a dryer. The option of using steam for heating is also possible with a dryer equipped with steam tubes. The drying gas exits the system as stream 11.

In FIG. 3, flue gas 28 flows counter-currently to activated carbon in MBR 21. SO₂ is removed from gas stream and converted to H₂SO₄ in activated carbon particles. H₂SO₄ saturated carbon particles flow counter-currently to the leaching water by gravity in downcomer 12, and by conveyor action in extractor 22. Drying gas 10 also flows counter currently to the carbon particles in dryer 23. Counter current operations ensure that the weak sulfuric acid stream 27 has the highest concentration possible, and the fully regenerated carbon after the rotary dryer operation has the lowest moisture content possible.

Efficient washing and drying by a standalone extractor and a standalone rotary dryer would maximize the time that carbon particles are in State (a) and increase the adsorption and reaction rate by one or two orders of magnitude as indicated by previous analysis.

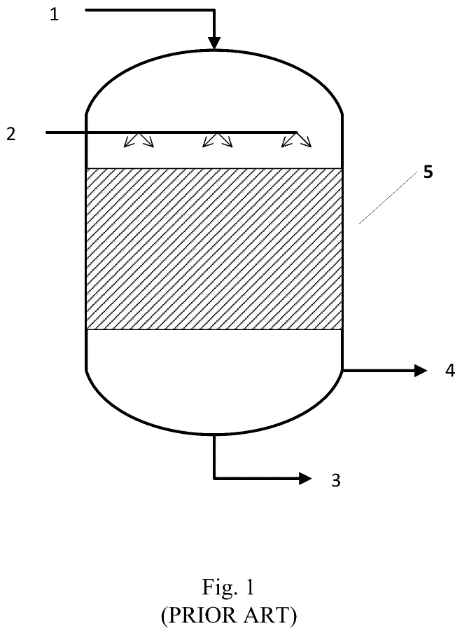

In addition to the low reaction rate, a packed bed as shown in FIG. 1 for SO₂ adsorption has two MOC problems. One is that there is no economical metal that can handle acid concentration of 10% to 30%, and it is often accompanied by temperature spike up to 200° F. during start of a washing cycle because of heat of dilution of sulfuric acid in carbon particles with washing water. FRP can handle such concentrations, but it can be charred if there is SO₃ slippage from a sulfuric acid plant final tower. Teflon can handle both weak acid of 10 to 30%, and SO₃ slippage, but it does not have the mechanical strength for large vessel construction.

Using separate sections for H₂SO₄ leaching and extraction (downcomer 12 and extractor 22), carbon particle washing and cleaning (extractor 22), blow dry or vacuuming (24/25), water evaporation (rotary dyer 23) and adsorption/reaction (MBR 21), the problem of MOC is solved.

If the carbon particles entering the MBR 21 from the rotary dryer 23 are free of surface water, MBR 21 would be operated in a totally dry environment. Carbon steel could be used as material of construction (MOC) for MBR in such a dry environment. The downcomer 12, being in contact with weak sulfuric acid of 10% to 30%, can be made of FRP for corrosion resistant. A short Teflon sleeve along the inner wall of FRP vessel 12 can be used to prevent process gas from touching FRP at the liquid-gas interface. Therefore, there is no SO₃ slippage worry here since the FRP is not in contact with process gas. There is no screw conveyor in the downcomer, and no metal component would be used, hence no corrosion problem. It is preferred that the downcomer be long enough, so that much of H₂SO₄ is extracted in the downcomer, and the weak acid concentration at the bottom of downcomer 15 is less than 5 wt %. If such a concentration limit is adhered, the extractor 22 can be made of SS-316, or more conservatively made of alloy Carpenter-20. Extractor 22 should have an efficiency that the carbon particles, after extraction of H₂SO₄ and blowing/vacuuming of exterior water, maintain a surface concentration of less than 1 wt % H₂SO₄. Such a low concentration of sulfuric acid would allow SS-304 to be used for the rotary dryer.

Another issue with activated carbon is its propensity for combustion. This problem is mitigated by emergency CO₂ supply through streams 13 and 14. Temperature sensors will be installed in the rotary dryer and the MBR, and abnormal temperature spikes will trigger rerouting of process gas 28 and the drying gas 10 and starting of emergency CO₂ purge of the rotary dryer and/or MBR.

The present invention ensures that:
1. The activated carbon particles are thoroughly washed and cleaned in extractor 22 with minimal H₂SO₄ left.
2. The activated carbon particles are fully regenerated, free (or with minimal) of H₂SO₄ and liquid water when they are in contact with SO₂ laden gas in the reaction section.
a. The activated carbon particles can be dried partially by incoming tail gas from a sulfuric acid plant, such gas is normally extremely dry but is limited to around 180° F.
b. The activated carbon particles can be dried partially by a power plant flue gas, although such a gas has high contents of CO₂ and water, but its temperature could be as high as 450° F. and still could provide the heat for drying of carbon particle.
c. Supplemental indirect heating by steam or direct heat by natural gas may be needed to dry the activated carbon particles completely.
d. Another carbon fire prevention method is using the tail gas or flue gas of a sulfuric acid plant or flue gas desulfurization process as a drying gas, the said drying gas' temperature is increased by secondary combustion of a fuel using the remainder of oxygen content in said drying gas. The oxygen content in such a tail gas or flue gas is typically 5-10% before secondary combustion. Secondary combustion with a controlled amount of fuel to make the oxygen content to near zero in such a gas would make the drying gas inert to combustion and carbon fire. This would also have the benefit of higher temperature, hence more efficient drying of the carbon particles.

If the above conditions can be satisfied, there should be minimal mass transfer resistance and adsorption/reaction rate should increase by an order of magnitude or more in comparison with a wet carbon reactor. The new process should have a higher reaction rate and lower CAPEX and operation costs.

### Use of Generated Weak Acid in Contact Sulfuric Acid Plant

The weak sulfuric acid generated by washing activated carbon can be used as dilution water for the contact sulfuric acid process. Water is needed per following reaction:

SO₃+H₂O=H₂SO₄

The total water needed is slightly over the stoichiometric ratio since the final commercial grade sulfuric acid concentrations can be 93.5% or 98.5%, and additional water is needed for diluting 100% H₂SO₄.

Therefore, there is a limit on how much water can be used for carbon washing. Too much water wash will violate water balance and will create a waste stream of weak acid. Water usage limits are used to set lower limits of regeneration weak acid concentrations as shown in Table 2.

TABLE 4
Regeneration Weak Acid wt % Limit for Acid Plant Water Balance

| Acid | | Contact Process | Carbon TGTU | | | |
|---|---|---|---|---|---|---|
| Plant | Gas SO₂ | SO₂ Conversion | SO₂ Conversion | H₂O % | Product | Weak |
| Type | Strength | % of Total SO₂ | % of Total SO₂ | in Air | Acid wt % | Acid wt % |
| SA | 8% | 97% | 3% | 3% | 98.5% | 19.00% |
| SA | 8% | 97% | 3% | 3% | 93.5% | 14.14% |
| DCDA | 11.5% | 99.7% | 0.3% | 3% | 98.5% | 1.97% |
| DCDA | 11.5% | 99.7% | 0.3% | 3% | 93.5% | 1.45% |

SA: Single Absorption; DCDA: Double Contact Double Absorption; for Sulfur Burning Plants Only.

Table 4 indicates that for treatment of double absorption sulfur burning acid plant tail gas, weak acid concentration of about 2% is good enough to satisfy water balance. This reduces the burden of MOC for the extractor and the downcomer. Length of the downcomer could be reduced. The extractor could be made of SS-316 for sure or even made of SS-304.

For a single absorption sulfur burning acid plant tail gas treatment, weak acid concentration requirements are much higher. Ideally, the acid concentration in the activated carbon particle should be as low as possible after regeneration since carbon is more active without H₂SO₄. At the same time, the weak acid product should have concentration as high as possible to satisfy water balance. To solve this conflict, a counter-current process is useful for activated carbon wash/regeneration.

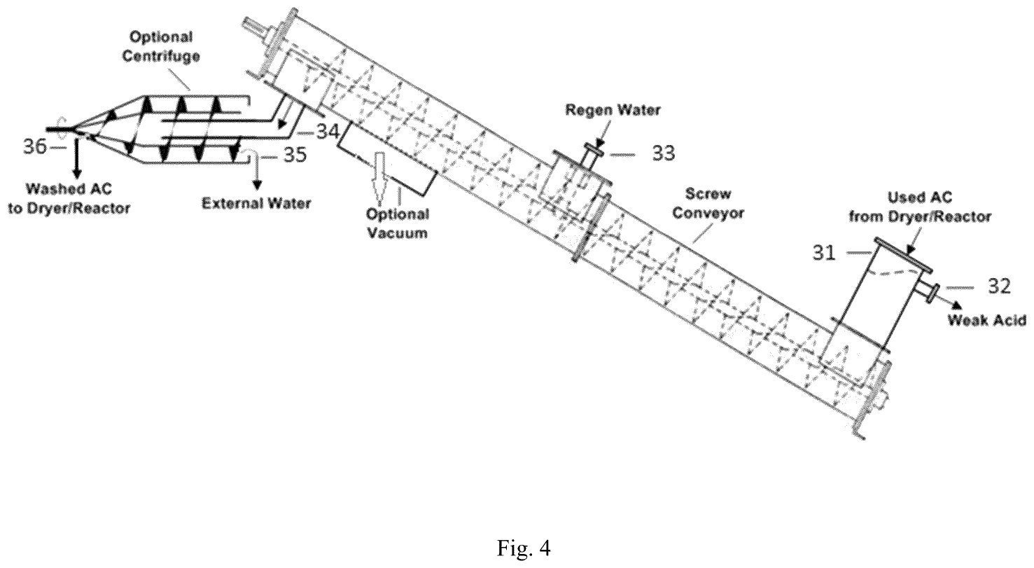

A continuous countercurrent wash process with a screw conveyor is shown in FIG. 4. Here a continuous decanter centrifuge is used to remove exterior water between particles.

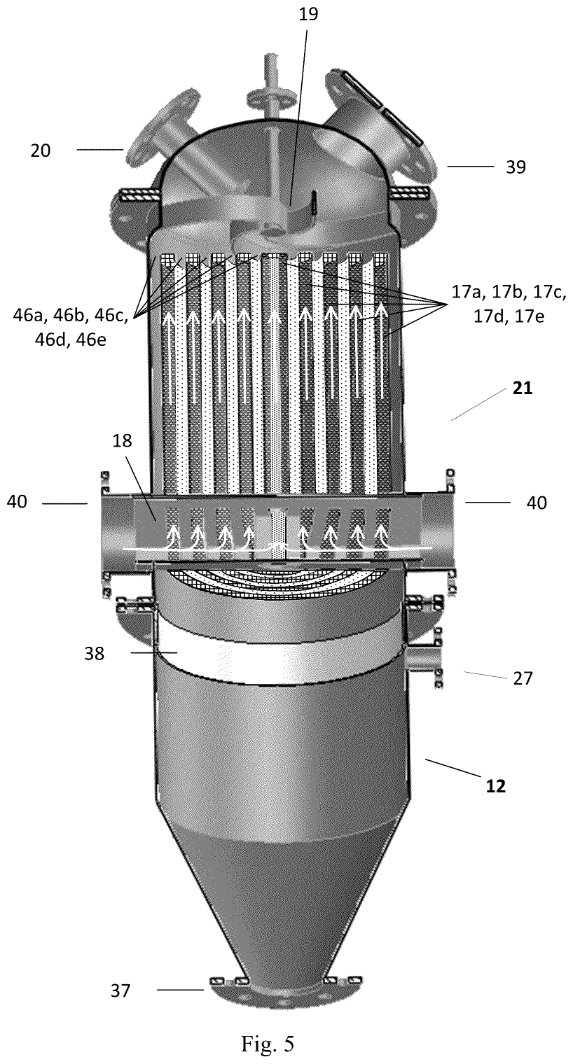

The details of the MBR construction are discussed in FIGS. 5-14.

FIG. 4 shows a continuous countercurrent wash process with a screw conveyor extractor and a continuous decanter centrifuge. The continuous decanter centrifuge is used to remove exterior water between particles.

As shown in FIG. 4, used activated carbon drops from MBR through the nozzle of downcomer 31, and sinks through weak acid by gravity and settles into the lower end of screw conveyor. The rotating screw carries activated carbon upward through the screw conveyor. Regen water flows into middle section of the screw conveyor through nozzle 33 and flows downward by gravity, counter-currently to the activated carbon direction. Regen water leaches H₂SO₄ from activated carbon and becomes weak sulfuric acid and exits the system through nozzle 32.

The washed carbon particles move upward above nozzle 33 to allow carbon particles and bulk water separation. Carbon particles will carry water inside the particle pores and outside the particles on external surface after separation from bulk water above nozzle 33. In order to reduce dryer heat duty for water evaporation later on, those external water is removed by mechanical means. One optional method uses vacuum suction to remove external water, another optional method uses a continuous decanter centrifuge to remove external water. Vacuum suction can be implemented on one section of the screw conveyor by perforating the wall of one section and allow vacuum to suck external water out of bulk carbon. In another option, wet carbon exits the screw conveyor through nozzle 34 and flows into a decanter centrifuge. External water on carbon surface is separated by centrifugal force and exits the centrifuge via a weir at location 35. Carbon particles without external water exit at location 36 and flow into rotary dryer for interior water evaporation.

FIG. 5 is a detailed drawing of MBR 21 and downcomer 12. Dried solid from the dryer enters from nozzle 20. Nozzle 20 extends into the top center of the reactor and discharge solid particles near the center above the screen cages 17a, 17b, 17c, 17d, 17e. The solid particles are not shown in this drawing, but they should fully occupy all the solid flow channels 46a, 46b, 46c, 46d, 46e. A rotary scraper 19 on top pushes and spreads the solid particles from center to all solid flowing channels 46a to 46e. The process gas enters from two nozzles 40 from opposite side of the vessel 21 and exits from top nozzle 39. The gas is distributed into screen cages by a distributor 18. The gas flow streams are shown by white arrows. Solid particles flow down to downcomer 12, passing gas distributor 18. The top surface of gas distributor 18 is sloped downward at the solid flow channels 46a to 46e, so that solid particles can pass the gas distributor without stopping. There is a Teflon sleeve 38 between downcomer 12 and MBR reactor 21. Liquid from extractor 22 flows up through nozzle 37 and exits the system through nozzle 27. Solid particles drop to extractor 22 through nozzle 37 by gravity. It is desired that liquid level be controlled between the lower and upper edges of Teflon sleeve 38, for protection of material of construction from acid and SO₃ attack. Downcomer 12 has a cone bottom to allow easy flow of solid particles.

As noted above, a packed bed reactor as shown in FIG. 1 has another disadvantage, namely an unacceptable gas phase pressure drop, especially when it is used to reduce tail gas emission of an existing process, such as a sulfuric acid plant or a flue gas desulfurization plant. An existing plant would have the main compressor capacity fixed and normally could only provide minimal additional pressure to drive the gas through additional equipment.

The present invention allows the solid adsorbent to flow down the moving bed reactor smoothly while in contact with a process gas, another objective is to design a moving bed reactor with minimal and controllable gas phase pressure drop.

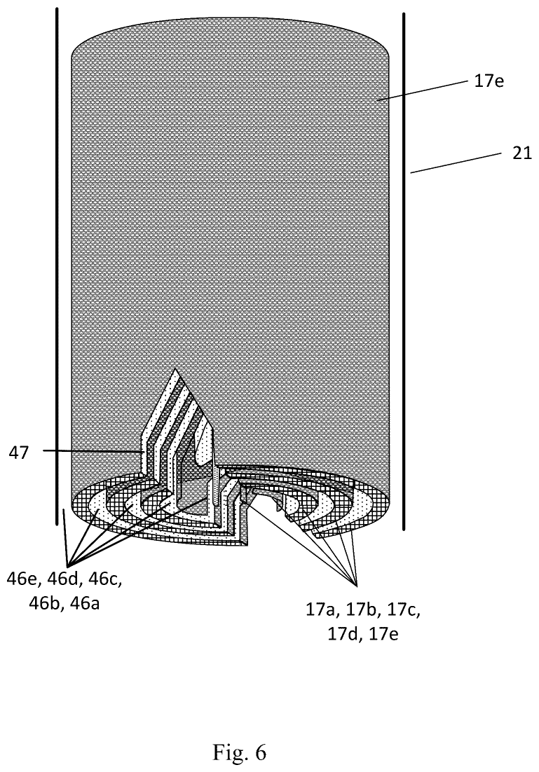

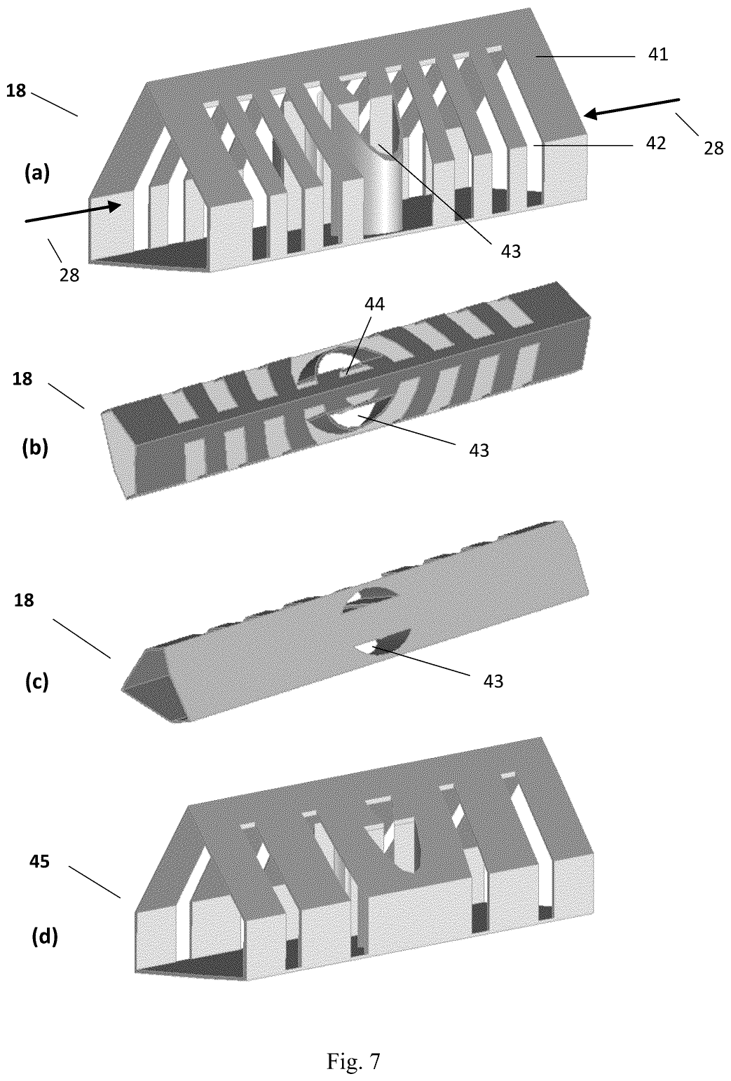

FIG. 6 shows the concentric screen cages 17a, 17b, 17c, 17d and 17e that are placed together inside reactor wall 21. Each screen cage has two pentagon shaped cutouts on the opposite side of its bottom. These pentagon-shaped cutouts match the shape of distributors 18 and 45 that are described in detail in FIG. 7. Gas enters the screen cages though multitudes of opening 47, which are openings from the pentagon cutouts. Solid particles flow through channels 46a to 46e, that are between concentric adjacent screen cages and between reactor wall 21 and the outermost screen cage 17e.

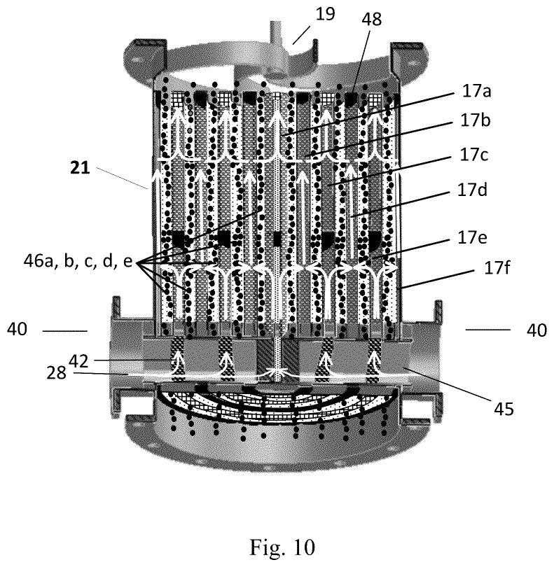

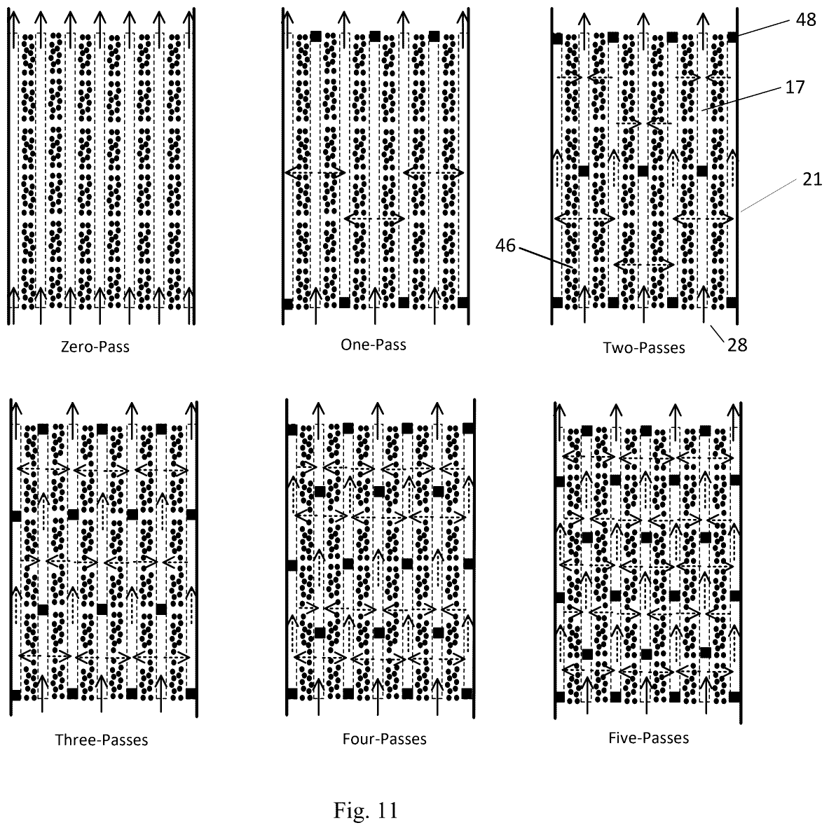

FIG. 7 shows the details of distributor 18 and distributor 45. Distributor 18 is for gas flow entering from bottom of all screen cages and exiting from the top of all screen cages. Distributor 45 is for gas flow entering from bottom of half of the screen cages, which is required for multi-passes radial flow configuration and will be described in FIGS. 10 and 11. FIG. 7(a) shows the trimetric view of distributor 18. Gas stream 28 entering from both sides of the distributor can flow into screen cages through multitude of opening 42, which matches multitude of opening 47 of screen cages correspondingly. The top surface 41 of the distributor is sloped downward so that solid particles can pass through. Since diameter of the screen cage 17a at the center is smaller than the width of the distributor bottom plate, the gas channel 44 of the distributor at the center must be narrowed down to go into screen cage 17a and an opening 43 needs to be cut at the bottom plate to allow solid particles in channel 46a to flow through the distributor. FIG. 7(b) are top view of distributor 18 and FIG. 7(c) are bottom view of distributor 18.

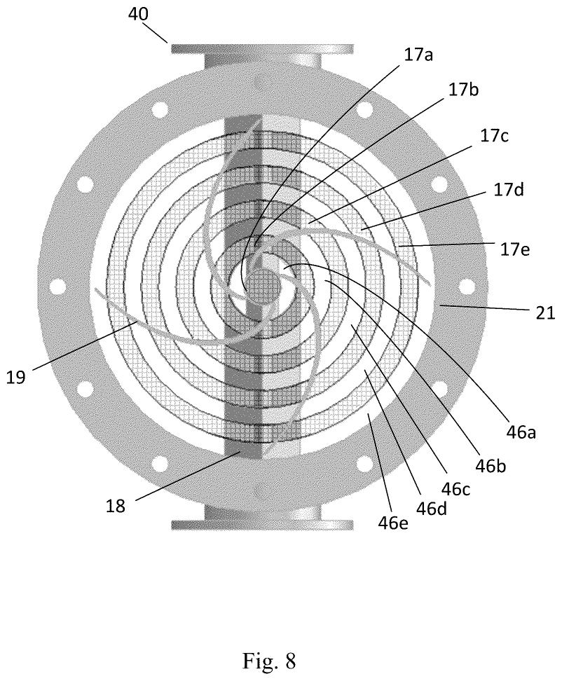

FIG. 8 shows the top view of gas distributor 18, reactor wall 21, reactor gas nozzle 40, screen cages 17a to 17e and rotary scraper 19. Rotary scraper 19 is on top of all other components here, it is shown as a partially transparent item so that screen cage 17a right below it is visible as well. Channels 46a to 46e are open to allow solid particles to flow down by gravity. At the position of gas distributor 18, solid particles can slide down due to the sloped top surface of the pentagon shaped distributor. Solid particles are dumped near channel 46a by the extended nozzle 20 in FIG. 5. Rotary scraper 19 then pushes solid particles to channels 46b to 46e. Solid particles are not shown here, but they should occupy all the channels and solid level should be above top of screen cages so that there is no gas bypassing in an open channel.

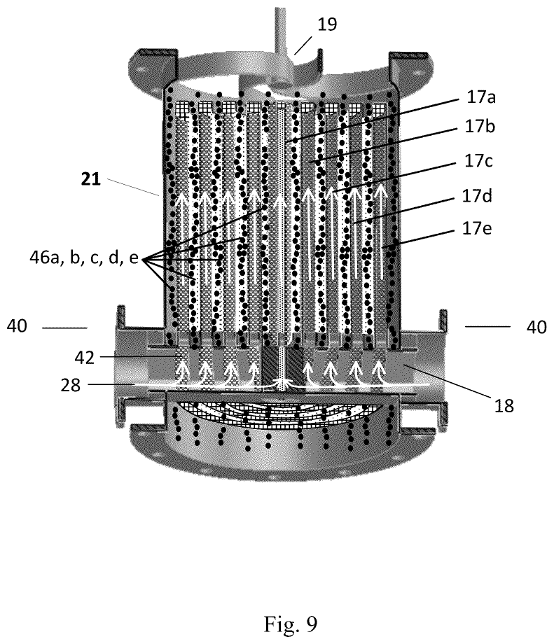

FIG. 9 shows a frontal cutout view of the moving bed reactor 21 with all the screen cages 17a to 17e, gas distributor 18, gas nozzles 40 and rotary scraper 19. Process gas 28 is fed into screen cages through multitude of opening 42 and is moving up in the screen cages as indicated by white arrows. Solid particles flow down through multitude of channels 46a, b, c, d, e. This configuration has all the gas streams flowing up within all the screen cages and is called zero pass configuration.

FIG. 10 shows a frontal cutout view of the moving bed reactor 21 with all the screen cages 17a to 17e, and an additional screen cage 17f (screen cage 17f has inner side to be a screen, and outside to be the vessel wall), gas distributor 45, gas nozzles 40 and rotary scraper 19. Process gas 28 is fed into screen cages through multitude of opening 42 and is moving through the reactor as indicated by white arrows. Solid particles flow down through plurality of channels 46a, b, c, d, e. This configuration has gas streams flowing across solid channels 46a to 46e two times and is called two-passes configuration. The gas streams are forced to pass through solid channels 46a, b, c, d, e by plurality of block rings 48 on top of screen cages 17b, 17d and 17f and plurality of block rings 48 in the middle of screen cages 17a, 17c and 17e. There are three physical differences between a zero-pass configuration and a two-passes configuration: one is that block rings are used in the screen cages in a two-passes configuration, another is distributor difference as shown by FIG. 7(a) zero-pass 18 and FIG. 7(d) multi-passes 45, the third is extra screen cage 17f.

In a zero-pass configuration, the main gas flow is always within the screen cages. Reactants must diffuse into the solid particle to be absorbed and converted into products. When reactants concentration is low and amount of reaction is less, this is a good economic option since the pressure drop is low. There are cases where a higher amount of reaction is required, then forcing the gas to pass the solid zone is an option at the sacrifice of increased pressure drop.

In fact, by placing the plurality of block rings 48 at various locations in the plurality of screen cages 17, zero to multiple passes can be realized. FIG. 11 shows flow paths of zero to five passes configuration. Solid flow channels 46 are the same in all cases. Gas flow paths 28 are indicated by black arrows in the drawing.

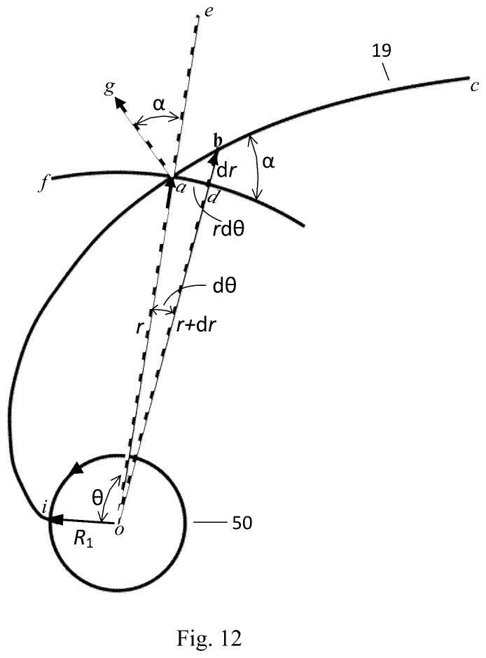

The rotary scraper 19 pushes and spreads solid to all solid channels 46a, b, c, d, e within a reactor. Without it, solid would just land in one location within the reactor. FIG. 12 shows how to design the shape of a scraper. The scraper 19 is composed of a blade (along curve i-a-b-c) and a rotary disc 50. The rotary disc 50 has a radius of R₁. There are two extreme cases of scraper design. One is a straight bar such as a blade constructed by a straight-line o-a-e. As straight blade o-a-e rotates counterclockwise, solid particles are pushed in the direction of a-f, i.e., azimuthal direction. Solid particles are not pushed outward; hence it is not an efficient design. On another extreme case, a blade can be made of a d-a-f arc. as the d-a-f arc rotates counterclockwise, the solid particles are not pushed to any directions at all (ignoring the friction force here). A properly designed blade should push the solid particles in an outward direction, such as pushed to the a-g direction.

Let a-g be the normal line of blade curve i-a-b-c at point a, i.e., line a-g is perpendicular to curve i-a-b-c at point a. The solid particles will be pushed to the normal direction of a curve (ignoring the friction force here). Let the angle in radian between radial line o-a-e and normal line a-g to be a, the angle in radian between the current position o-a and starting position o-i as θ, radial distance o-a of current position a be r. As the curve i-a-b-c turns a differential radian degree of dθ, radial line o-d-b would be the new radial line for curve i-a-b-c. The length of the radial line o-d-b is r+dr, where dr is the radial line increase after turning dθ in radian. The length of arc a-d would be rdθ. Angle b-a-d should be equal to a because line a-g is perpendicular to curve i-a-b-c and line a-e is perpendicular to arc f-a-d.

Within triangle b-a-d, the following relationships hold:

$$\frac{dr}{rd θ} = tan ( α ) \qquad ( 8 )$$

$$\frac{dr}{r} = tan ( α ) d θ \qquad ( 9 )$$

$$ln \frac{r}{{R}_{1}} = tan ( α ) θ \qquad ( 10 )$$

$$r = {R}_{1} {e}^{tan ( α ) θ} \qquad ( 11 )$$

Equation (11) is the general design equation for the blade curve i-a-b-c. Where θ is the radian (0-2π) of the current position a from the starting point position i, r is the radial distance from current point a on the curve to the center point o. Angle α is the angle of the normal line a-g of blade curve at each point with respect to the radial line o-a-e at the same point. R₁ is the radius of rotary disc 50.

When radian α=π/4 as shown in FIG. 12, tan(α)=1, Equation (11) reduces to:

$$r = {R}_{1} {e}^{θ} \qquad ( 12 )$$

A blade constructed with α>0 and α<π/2 would perform outward push of solid particles when rotating. The smaller the angle α is, the larger the outward push force will be applied to solid particles.

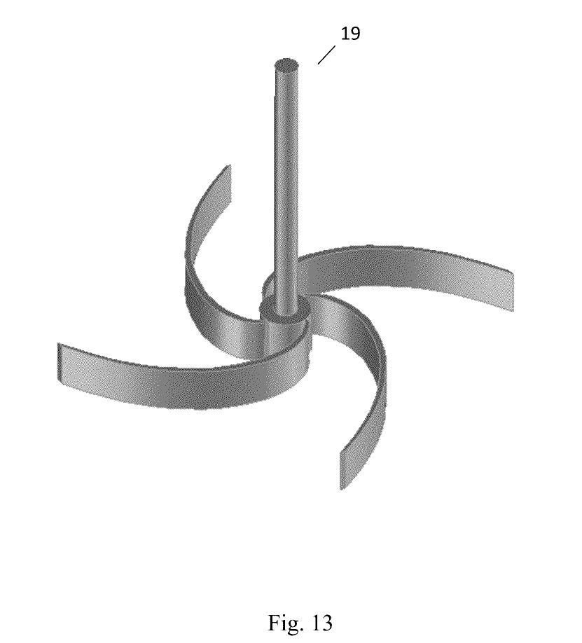

FIG. 13 shows a rotary scraper 19 with four evenly spaced blades that are constructed using Equation (12) with α=π/4.

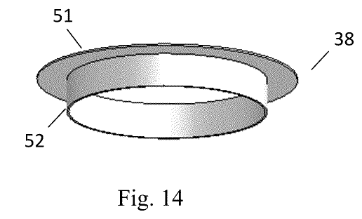

FIG. 14 shows a Teflon sleeve 38. Gasket 51 can be inserted between flanges of carbon steel reactor 21 and fiber-reinforced plastic (FRP) downcomer 12. Sleeve 52 lines the FRP downcomer 12.

The construction methods of concentric screen cages and gas distributors such as shown in FIGS. 5-11 for moving bed reactors can be similarly applied for fixed bed reactors, in which the catalyst is not moving, and catalyst is discharged only after it is deactivated. Those methods provide an easy way of catalyst replacement for fixed bed reactors. Those methods also provide a better way of reducing and controlling pressure drops for fixed bed reactors.

The construction methods of concentric screen cages and gas block rings such as shown in FIG. 11 can be similarly applied for concentric particulate filters or concentric mist eliminators.

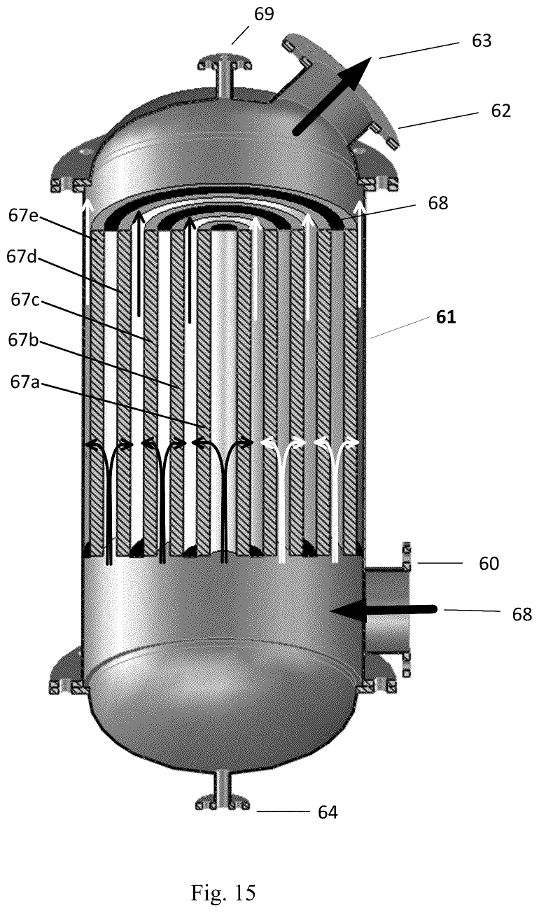

A concentric multi-element filters/mist eliminators setup is shown in FIG. 15 in a cut out view. In a filter house 61, five concentric filter elements 67a to 67e are nested in each other. Multitude of gas block ring 68 are placed at top and bottom to force gas to pass filter elements. Gas stream 68 enters the filter house through nozzle 60. Gas exits as stream 63 through nozzle 62. The gas flow paths are indicated by arrows. There is a high vent nozzle 69 and a low drain nozzle 64.

Concentric filter elements arrangement as shown in FIG. 15 provides a better way of controlling pressure drops for filters and mist eliminators. It also provides a better way of utilization of filter house volume, and a better way of scaling up of filtering or mist eliminating processes in comparison with single element filters or mist eliminators.

### Multi-Pollutants Control

Activated carbon can also adsorb mercury [7] and NOx. The adsorption capacity of NO on activated carbon can be increased dramatically if O₂ and moisture are available, similar to that of SO₂ adsorption. Similarly, mercury in oxidized form is easier to adsorb and more soluble in solutions. The carbon regeneration method can be the same as described by FIG. 3. SO₂, NOx and mercury from a power plant flue gas could be adsorbed together and resulting spent activated carbon can be regenerated in a similar way. Sulfuric acid plant tail gas would also have NOx in addition to SO₂, and both can be adsorbed, oxidized, and removed together with FIG. 3 process. An alternative to oxidative adsorption of NOx, NOx can be reduced to N₂ by ammonia addition in an MBR. Ammonia should be introduced at the upper section of MBR when most SO₂ is already removed from process gas stream.

### An Alternative Spent Activated Carbon Regeneration Method.

The general method of spent activated carbon regeneration using rotary kilns and or hearth furnaces requires high temperature of 1000° F., and loss of 5-10% carbon. For many processes, such as oxidative adsorption of sulfureous or NOx compounds, the resulting products are water soluble and can be removed by water washing or leaching operation. The process as described by FIG. 3 can be used for spent carbon regeneration of all adsorption processes that produce liquid soluble and extractable products. This regeneration method is less energy intensive since leaching and drying does not require a temperature of 1000° F. This method also does not lose 5-10% carbon content after each regeneration.

### A Design Example for a Single Absorption Sulfuric Acid Plant Tail Gas SO₂ Removal

A 73 STPD (short ton per day) single absorption sulfuric plant tail gas has 1500 ppm of SO₂ at a temperature of 180° F. This tail gas is treated with the FIG. 3 process to remove SO₂ down to 20 ppm. A weak acid of 30% is produced with a weak acid production rate of 2.19 STPD (100% basis). The main process design conditions are listed in Table 5.

TABLE 5
Tail Gas Treatment Unit for a 73
STPD Single Absorption Acid Plant

| | Rotary Dryer | Extractor | Moving Bed Reactor |
|---|---|---|---|
| Carbon Weight (lbs) | 618 | 1098 | 7821 |
| Vessel Volume, (ft³) | 177 | 31 | 447 |
| Gas Flow In, (acfm) | 1570 | | 9237 |
| Water Flow In, (ft³/hr) | | 6.8 | |
| Solid Flow In, (lb/hr) | 1367 | 1094 | 911 |

The moving bed reactor has the largest vessel volume and carbon volume among the three main pieces of equipment. It can be made of carbon steel which is relatively cheap. The extractor requires more expensive metal as MOC, however, its size is the smallest, hence less overall cost when all equipment are considered together. A design in which an individual operation is confined in a single piece of equipment could result in higher operational efficiency, lower CAPEX and OPEX, and easy trouble shooting of operational problems.

The foregoing disclosure and description of the invention is illustrative and explanatory thereof. Various changes in the details of the illustrated construction can be made within the scope of the present invention without departing from the true spirit of the invention. The present invention should only be limited by the following claims and their legal equivalents.

### REFERENCES

Wahyu Hasokowati, “Loading, Draining and Steady State Operation of a Trickle Bed Reactor”, Master Thesis, University of Waterloo, Waterloo, Canada, 1993
Neran K. Ibraheem, Shahrazad R. Raouf, Zainab A. Naser, “Removal of SO₂ over Modified Activated Carbon in Fixed Bed Reactor: I, Effect of Metal Oxide Loadings and Acid Treatment”, Iraqi Journal of Chemical and Petroleum Engineering, Vol. 15, NO. 4 (December 2014) 25-35.
P. M. Haure, R. R. Hudgins and P. L. Silveston, “Periodic operation of a trickle bed reactor”. AIChE Journal, 35(9), 21437(1989).
S. K. Gangwal, G. B. Howe, J. J. Spivey, P. L. Silveston, R. R. Hudgins, J. G. Metzinger. “Low-temperature carbon-based process for flue-gas cleanup”, Environmental Progress, 12(2), 28(1993).
Arthur Kohl, Richard Nielsen. “Gas Purification”, Gulf Publishing Company, Houston, Texas, 1997.
Tsuji, K; Shiraishi, I; Olson, D. G. “The reduction of gas phase air toxics from combustion and incineration sources using the GE-MITSUI-BF activated coke process”, EPRI-TR-105258-Vol. 3; CONF-950332-Vol. 3, TRN: 95:007569-0013.
Regina Rodriguez, Domenic Contrino, David Mazyck, “Role of Activated Carbon Precursor for Mercury Oxidation and Removal: Oxidized Surface and Carbene Site Interaction”, Processes 2021, 9(7), 1190; https://doi.org/10.3390/pr9071190.

1. A system for oxidative adsorption with a regenerated active carbon, the system comprising:
a moving bed reactor having a process gas inlet adjacent a bottom thereof and a regenerated carbon inlet adjacent a top thereof;
a downcomer in fluid communication with the bottom of the moving bed reactor such that carbon particles from the moving bed reactor pass into the downcomer, the downcomer having a fluid outlet;
an extractor in fluid communication with a bottom of the downcomer, the extractor having a fluid inlet adjacent a top thereof, the extractor adapted to move the carbon particles received from the downcomer in an upward direction; and
a dryer having a first end and a second end, said first end being connected to the top of the extractor so as to receive carbon particles from the extractor, the second end being connected to the regenerated carbon inlet of the moving bed reactor so as to introduce carbon particles to the moving bed reactor.

2. The system of claim 1, wherein the extractor comprises a conveyor screw having a rotating shaft.

3. The system of claim 1, wherein the dryer is a rotary drum dryer.

4. The system of claim 1, further comprising a blow dryer positioned in a conduit between the top of the extractor and the first end of the dryer.

5. The system of claim 1, wherein the moving bed reactor comprises a carbon dioxide inlet adjacent the bottom thereof.

6. The system of claim 1, further comprising a sleeve positioned between the moving bed reactor and the downcomer.

7. The system of claim 1, wherein the moving bed reactor comprises a plurality of screen cages with a plurality of channels therebetween, wherein the carbon particles from the dryer pass through the plurality of channels towards the downcomer.

8. The system of claim 7, wherein the moving bed reactor further comprises a rotary scraper positioned above the plurality of screen cages, the rotary scraper adapted to push the carbon particles into the plurality of channels.

9. The system of claim 1, wherein the downcomer has a cone-shaped bottom.

10. The system of claim 7, wherein the plurality of screen cages are concentrically arranged.

11. The system of claim 7, wherein the moving bed reactor comprises a distributor positioned below the plurality of screen cages, the distributor having a plurality of openings aligned with the plurality of screen cages so as to allow process gas to pass from the process gas inlet into the distributor and into the plurality of screen cages.

12. The system of claim 11, wherein the distributor has a plurality of sloped walls positioned on opposite sides of each of the plurality of openings such that carbon particles passing through the plurality of channels of the moving bed reactor slide along the sloped walls so as to be guided into the downcomer.

13. The system of claim 7, wherein the plurality of screen cages are provided with a plurality of blockages so as to define a gas path through the plurality of screen cages and the plurality of channels.

14. The system of claim 6, wherein:
the sleeve is constructed of Telfon®;
the moving bed reactor is constructed of carbon steel; and
the downcomer is constructed of fiber-reinforced plastic (FRP).

15. The system of claim 14, wherein the sleeve is positioned so as to line the interior of the downcomer.

16. A method for oxidative adsorption in a moving bed reactor with a regenerated active carbon, the method comprising:
passing a process gas through a moving bed reactor, the moving bed reactor containing activated carbon particles;
flowing the activated carbon particles into a downcomer connected to an extractor, the downcomer and extractor containing a leeching liquor;
washing the activated carbon particles so as to remove oxidative products resulting from the process gas passing through the moving bed reactor;
removing the oxidative products from the downcomer, the oxidative products being in the form of a weak acid;
moving the washed carbon particles upwardly through the extractor;
drying the washed carbon particles; and
flowing the dried carbon particles into the moving bed reactor.

17. The method of claim 16, wherein the step of drying comprises:
blow drying the washed carbon particles; and
further drying the washed carbon particles in a rotary dryer or a fluidized bed dryer.

18. The method of claim 16, wherein the process gas contains sulfurous or nitrogen oxide compounds, and wherein the weak acid is H₂SO₄ or HNO₃.

19. The method of claim 16, wherein the moving bed reactor comprises a plurality of screen cages with a plurality of channels therebetween, wherein the activated carbon particles through the plurality of channels towards the downcomer, and wherein the process gas passes through the plurality of screen cages and the plurality of channels.

20. The method of claim 16, wherein the step of drying comprises using tail gas or process gas as a drying gas.
